(19) United States
(12) Patent Application Publication
(10) Pub. No.: US 2025/0069156 A1
(43) Pub. Date: Feb. 27, 2025

(54) GRIEF AND LOSS MANAGEMENT SYSTEM

(71) Applicant: DIVERGENT COLLABORATIVE GROUP, INC., VIRGINIA BEACH, VA (US)

(72) Inventors: CHERYL OSBOURNE CHAVERS, HAMPTON, VA (US); CLAUDIUS RODGERS, VIRGINIA BEACH, VA (US)

(73) Assignee: DIVERGENT COLLABORATIVE GROUP, INC., VIRGINIA BEACH, VA (US)

(21) Appl. No.: 18/236,471

(22) Filed: Aug. 22, 2023

Related U.S. Application Data
(60) Provisional application No. 63/354,247, filed on Jun. 22, 2022.

(51) Int. Cl. G06Q 50/00; G06F 9/451; G06F 21/45; G06Q 10/107

(52) U.S. Cl. CPC G06Q 50/01; G06F 9/451; G06F 21/45; G06Q 10/107

(57) ABSTRACT

A grief and loss management system, along with methods and computer programmable product for implementation of same, is disclosed. The grief and loss management system enables the provision of support to a bereaved individual upon the passing of a loved one by way of automated messages, which may include text, email, etc. The grief and loss management system also enables the recordation and highlighting of certain milestones associated with the bereaved individual's loved one which would enable individuals providing support to the bereaved, to do so at opportune times in relation to the milestones.

### CROSS-REFERENCE TO RELATED APPLICATIONS AND PRIORITY CLAIMS

This patent application is a Non-Provisional patent application which claims priority under 35 U.S.C. § 119(e) to U.S. Provisional Patent Application Ser. No. 63/354,247, titled “GRIEF AND LOSS MANAGEMENT SYSTEM” filed Jun. 22, 2022. The entire disclosure of the aforementioned provisional patent application is incorporated by reference into this non-provisional patent application as if fully stated herein.

### FIELD OF THE INVENTION

The present invention relates in general to systems, computer implemented methods, and computer programmable code for the implementation of a grief and loss management system configured to, inter alia, notify users of key milestones, dates, anniversaries etc. pertaining to loved ones who have passed away, in addition to other types of losses.

### BACKGROUND OF THE INVENTION

Individuals going through times of bereavement and grief are often not supported by their community members to help them deal with their loss. This lack of support may not be intentional but can occur for a host of reasons. For instance, grieving individuals may have emotions that come in waves or on specific occasions. In addition, their friends and family may not be aware of a bereaved/grieved individual's acute needs. Further still, the concept of bereavement/grief is not holistically embraced by society, and, as a result, misconceptions and maladaptive behaviors have manifested surrounding the phenomena of death and loss. The bereaved/grieved are often left to mourn alone, while surrounded by a society ill-equipped to acknowledge and provide the support that the bereaved/grieved require. By acknowledging the grief associated with their loss, and providing support a cultural shift can occur in which healthy coping strategies emerge related to grief and loss.

Accordingly, there is a need for a platform that enables on-going and systematic acknowledgement of the milestones associated with loss, operation/implementation of which the bereaved/grieved may find acceptable to embrace their loss. There is also a need for a platform or system that would memorialize the indelible impression the loss has had on the bereaved/grieved individual's life. Aspects of embodiments of the present invention, by operation/implementation of the contemplated platform, seek to change the narrative on grief and loss and let the bereaved/grieved know they are not alone. Aspects of embodiments of the present invention, by operation/implementation of the contemplated platform also intend to remind a bereaved/grieved individual that their loss will be remembered along the spectrum of life.

In addition, there is a need for a platform that would enable community members to receive notification reminders about important milestones associated with the bereaved/grieved. The notifications will alert community members to support the bereaved/grieved in whatever capacity the community members determine is most feasible. Such notifications may include electronic messages of support or even ordering flowers or other gifts to be delivered, through a mobile application. Aspects of embodiments of the present invention, by operation/implementation of the contemplated platform contemplate transmission of notification reminders, which occur prior to a milestone to alert a community member that a noteworthy milestone is approaching in the life of the bereaved/grieved individual. This advance notice will enable the community member to prepare to provide support emotionally or tangibly. Exemplary grief milestones to be acknowledged may include, but not be limited to: 1 month, 6 month, and 1-year anniversaries of the loss. Milestones for the bereaved/grieved could also include assorted special days and holidays, e.g., birthdays, Valentine's Day, Christmas, wedding anniversary, Mother's Day, Father's Day, etc. Aspects of embodiments of the present invention, by operation/implementation of the contemplated platform, can help not only the bereaved/grieved, but also individuals in their support system by making it easier for them to demonstrate empathy and provide emotional and tangible support.

An aspect of an embodiment of the present invention contemplates operation/implementation of a customizable life event management support system/platform for users for life event applications that may include, but not be limited to, death, divorce, job loss etc. Operation of the contemplated platform/system may include the creation of a support community. The contemplated platform/system may include the promotion and support of interactions between community members.

Aspects of embodiments of the present invention seek to, inter alia: (1) provide a means for a user (such as a bereaved/grieved individual, relative, friend, etc.) to create life events for themselves or a member of their community (2) allow users to join or be added to an individual's life events (3) allow members of a life event to interact with each other in a way that is mutually supportive (4) provide support, tools, and resources to users to help with the grief and loss process (5) to support timely notifications on current and upcoming events (6) coordinate the management of major life events (7) identify meaningful milestones and (8) create a supportive community for the bereaved/grieved.

The contemplated platform/system, according to aspects of embodiments of the present invention, improves the life event management process by providing support to bereaved/grieved individuals, while supporting them through the grief & loss process. The contemplated platform/system also allows for users to create a life event, include details of the events, establish meaningful milestones, and build a support community. User may also be notified about upcoming events and about supportive communication from members of the community.

The contemplated platform/system, according to aspects of embodiments of the present invention, also provides timely notifications about milestone and supportive communications, while also allowing users to have multiple life events associated with themselves and others.

The contemplated platform/system, according to aspects of embodiments of the present invention, brings multiple aspects of the grief and loss process into a single place or central location. It is from this central location that other contemplated operations may issue from such as, inter alia, notifications, communications between members etc.

The contemplated platform/system, according to aspects of embodiments of the present invention, provides real-time support on past and upcoming milestones related to one or more life events. In addition, the contemplated platform/system, according to aspects of embodiments of the present invention, provides meaningful notifications about past and upcoming events while also providing support to the bereaved/grieved individual.

An aspect of an embodiment of the present invention contemplates a grief and loss management system, which may include: hardware processor(s) configured to perform a predefined set of basic operations in response to receiving a corresponding basic instruction selected from a predefined native instruction set of code, memory, in communication with the hardware processor(s), an onboarding module, which may include a first set of machine code selected from the native instruction set for initial onboarding of user(s) to the grief and loss management system and second set of machine code for enabling creation of a community circle of the user(s), a communications module, which may include a set of machine code selected from the native instruction set for enabling interaction(s) between grief and loss management system user(s) and for enabling communication between modules of the grief and loss management system, an events module, which may include a set of machine code selected from the native instruction set for collection of any one or more of the user(s)': events, milestones, and an offer support module, which may include a set of machine code selected from the native instruction set for enabling communication between system user(s)s, where the hardware processor(s) is in communication with the system modules. In an aspect of an embodiment of the present invention, the communications module may be present and/or part of the hardware processor.

In an aspect of an embodiment of the present invention, the events modules may include: a “reach out for support” sub-module, a “life events” sub-module, a milestones sub-module and a “my circles” sub-module.

In an aspect of an embodiment of the present invention, the “reach out” sub-module may include a set of machine code selected from the native instruction set for enabling the user(s) to communicate with the user(s)' community circle.

In an aspect of an embodiment of the present invention, the life events sub-module may include a set of machine code selected from the native instruction set for enabling collection and storage of life event information provided by the user(s).

In an aspect of an embodiment of the present invention, the milestones sub-module may include a set of machine code selected from the native instruction set for enabling collection and storage, from the user(s), of milestones related to a life event.

In an aspect of an embodiment of the present invention, the my circles sub-module may include a first set of machine code selected from the native instruction set for enabling the user(s) to provide access to portions of the system to members of the user(s)' community circle and a second set of machine code for enabling collection and storage of member information of the user(s)' community circle.

Another aspect of an embodiment of the present invention contemplates a computer implemented method of operating a grief and loss management system, which may include, executing on processor(s), the steps of: operation of an onboarding module, which may include step(s) for enabling creation of a community circle of grief and loss management system user(s) and enabling creation of a community circle of the user(s), operation of a communications module, which may include step(s) for: enabling interaction(s) between grief and loss management system user(s), implementing interaction(s) between grief and loss management system user(s), enabling communication between modules of the grief and loss management system and implementing communication between modules of the grief and loss management system, operation of an events module, which may include step(s) for: collection of any one or more of the grief and loss management system user(s)': events, milestones, and management of any one or more of the grief and loss management system user(s)': events, milestones, and operation of an offer support module, which may include step(s) for communication between system user(s)s.

In another aspect of an embodiment of the present invention, the operational steps of the events module may include step(s) for: enabling the grief and loss management system user(s) to communicate with the grief and loss management system user(s)' community circle, enabling collection and storage of life event information provided by the grief and loss management system user(s), enabling collection and storage, from the grief and loss management system user(s), of milestones related to a life event, enabling the grief and loss management system user(s) to provide access to portions of the system to members of the user(s)' community circle and enabling collection and storage of member information of the grief and loss management system user(s)' community circle.

A further aspect of an embodiment of the present invention contemplates a computer programmable product which may include a non-transitory computer readable medium having control logic stored therein for causing processor(s) to operate a grief and loss management system which may include executing on processor(s), computer readable code for: operation of a communications module, which may include step(s) for: enabling interaction(s) between grief and loss management system user(s), implementing interaction(s) between grief and loss management system user(s), enabling communication between modules of the grief and loss management system and implementing communication between modules of the grief and loss management system, operation of an events module, which may include step(s) for: collection of any one or more of the grief and loss management system user(s)': events, milestones, and management of any one or more of the grief and loss management system user(s)': events, milestones, and operation of an offer support module, which may include step(s) for communication between system user(s)s.

In a further aspect of an embodiment of the present invention, the operational steps of the events module may include step(s) for: enabling the grief and loss management system user(s) to communicate with the grief and loss management system user(s)' community circle, enabling collection and storage of life event information provided by the grief and loss management system user(s), enabling collection and storage, from the grief and loss management system user(s), of milestones related to a life event, enabling the grief and loss management system user(s) to provide access to portions of the system to members of the user(s)' community circle and enabling collection and storage of member information of the grief and loss management system user(s)' community circle.

Yet further aspects of embodiments of the present invention contemplate systems, computer programmable product, and computer implemented methods required for the full implementation of the flow charts, modules, processes and drawings disclosed within and/or accompanying this specification.

Aspects of embodiments of the present invention contemplate the use of modules in implementation of the process(es) outlined herein and operation of components of the system also disclosed herein.

Aspects of embodiments of the present invention contemplate the grief and loss management system to include a set of machine code selected from the native instruction set for enabling the display of a tab or link on each page for the respective module and/or sub module, where the link activates operation of the respective module and/or sub module when a user taps, swipes, selects, or clicks on the link using either the user's finger, mouse, or any other operative device.

Aspects of embodiments of the present invention contemplate each module and/or sub-module to include a set of machine code selected from the native instruction set for enabling the display of a tab or link on each page for the respective module and/or sub module, where the link activates operation of the respective module and/or sub module when a user taps, swipes, selects, or clicks on the link using either the user's finger, mouse, or any other operative device.

Aspects of embodiments of the present invention contemplate the use of special purpose or general-purpose computer system(s) that includes computer hardware such as processor(s) and system memory. These processor(s) may be configured to perform a predefined set of basic operations in response to receiving a corresponding basic instruction selected from a predefined native instruction set of computer executable code. Aspects of embodiments of the present invention may include a set of machine code selected from the native instructions set of the server(s)/processor(s) to perform specific functions and/or operations. As the native instructions set is a discrete code recognized by the hardware processor(s) which may be built into the hardware processor(s) and presents the way the system communicates with the hardware processor(s). In an aspect of an embodiment of the present invention, the native instructions set specify certain registers for arithmetic, addressing and/or control functions. In addition, the native instructions set can specify addressing modes which are utilized to interpret operands. Combination and/or permutations of the different native instructions may be done for more complex computer operations or functionality. Aspects of embodiments of the present invention contemplate the use of such special purpose or general-purpose computer system(s) in the implementation of the contemplated invention herein by execution of machine code discussed above.

Aspects of embodiments contemplate computer program product stored on computer-readable media for carrying or storing computer-executable instructions and/or data structures. Such computer-readable media can be any available media that can be accessed by a general-purpose or special-purpose computer system. Such computer-readable media may include, but not be limited to, physical storage media that store computer-executable instructions and/or data structures, of which may include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures. these can be accessed and executed by the general-purpose or special-purpose computer system to implement the disclosed functionality of the invention.

Computer-executable instructions comprise, for example, instructions and data which, when executed by the processor(s), cause a general-purpose computer system, special-purpose computer system, or special-purpose processing device to perform a certain function or group of functions. Computer-executable instructions may be, for example, binaries, intermediate format instructions such as assembly language, or even source code.

In an aspect of an embodiment of the present invention, the term “module” may represent self-contained computer hardware. In another aspect of an embodiment of the present invention, the term “module” may represent computer hardware on a designated computer chip or separate computer chips. In a further aspect of an embodiment of the present invention, the modules may be hardware resident on one chip, component, separate components, a remote server, database, some or each of which (or all of which, in one aspect of an embodiment of the present invention) may be separate and distinct from the device, or any combination thereof.

In an aspect of an embodiment of the present invention, a module may be essential units of software that encompass executable machine code selected from the native instruction set and all related dependencies. The module in this case may be accessible by or in communication with the special/general purpose processor(s) for execution of the module's executable machine code. In another aspect of an embodiment of the present invention, the term module may represent computer hardware, essential units of software that encompass executable machine code selected from the native instruction set and all related dependencies, and processor(s), all within one contained unit such as one chip, component, separate components, a remote server, database, where the processor(s) has access to, and is able to execute the executable machine code.

In an aspect of an embodiment of the present invention, the processor(s) may be configured to coordinate, implement and/or assign tasks to, from and/or among the module(s). In a further aspect of an embodiment of the present invention, module components may also, in an operational context, be components of other modules.

In a further aspect of an embodiment of the present invention, steps, processes, operations or methods undertaken by the systems and/or system components, as discussed above, may be implemented by execution, on one or more servers or processors configured to perform a predefined set of basic operations in response to receiving a corresponding basic instruction selected from a predefined native instruction set of codes. This native instruction set of codes or machine language instruction codes may be built into servers/processors of system components. As such, different operations contemplated by the disclosure above, may be made possible by the selection of machine codes from specific machine language instruction codes. Additional complex operations may be made possible by the combination of different sets of machine language instruction codes.

Further aspects of embodiments of the present invention contemplate the use of non-transitory computer programmable product and computer-implemented methods for the implementation of the different processes and modules outlined above. The same may be found installed on any or all of the components discussed in this application including, without limitation, the mobile device(s), registries, etc.

Yet further aspects of embodiments of the present invention contemplate execution of computer code resident on devices, system of devices, and communication media such as wide area networks, the internet etc. enabling the contemplated transactions.

### BRIEF DESCRIPTION OF DRAWINGS

FIG. 1 illustrates a grief and loss management system according to an aspect of an embodiment of the present invention.

FIG. 2 illustrates an exemplary operational process of a grief and loss management system according to aspects of embodiments of the present invention.

FIG. 3 illustrates an exemplary privacy protection element of a grief and loss management system according to aspects of embodiments of the present invention.

### DETAILED DESCRIPTION OF DRAWINGS

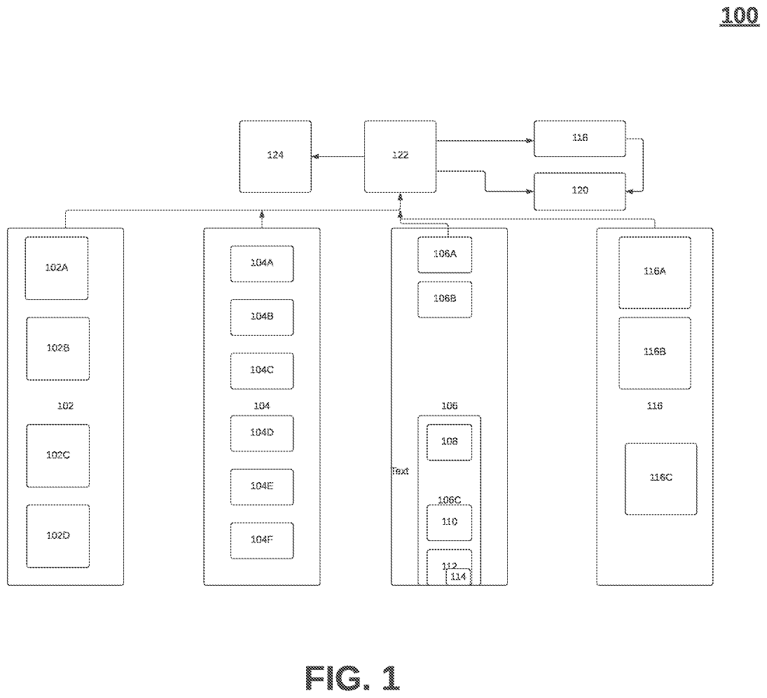

Referring now to FIG. 1, a grief and loss management system 100, is shown according to aspects of embodiments of the present invention. grief and loss management system 100 may include: at least one hardware processor 118 configured to perform a predefined set of basic operations in response to receiving a corresponding basic instruction selected from a predefined native instruction set of code, memory 120, in communication with at least one hardware processor 118, onboarding module 102, which may include a first set of machine code selected from the native instruction set for initial onboarding of at least one user to grief and loss management system 100 and second set of machine code for enabling creation of a community circle of the at least one user. Such “circle” may include people who may form the support network for the user(s). grief and loss management system 100 may also include: menu module 104, which, in turn, may include a set of machine code selected from the native instruction set for displaying grief and loss management system 100's navigation options and information pertaining to grief and loss management system 100, communications module 122, where communications module 122 may include a set of machine code selected from the native instruction set for enabling at least one interaction between users of grief and loss management system 100 and for enabling communication between modules, processor 118, and/or memory 120 of grief and loss management system 100. grief and loss management system 100 may also include events module 106, which may include a set of machine code selected from the native instruction set for collection of any one or more of the at least one user's: events, milestones, and offer support module 116, which may include a set of machine code selected from the native instruction set for enabling communication between system users. In an aspect of an embodiment of the present invention, at least one hardware processor 118 may be in communication with grief and loss management system 100 modules. In an aspect of an embodiment of the present invention, processor 118 may execute the machine code of aforesaid modules and sub modules of grief and loss management system 100. In an aspect of an embodiment of the present invention, communications module 122 may be present and/or part of the hardware processor 118.

Grief and loss management system 100's navigation options may include display of link/activation buttons displayed on a screen or page (including for example, landing page(s)) for each of grief and loss management system 100's modules and, in an aspect of an embodiment of the present invention, grief and loss management system 100's sub-modules. Activation of any link/activation button, which could be done by a user tapping on a particular button, depressing an activation button, swiping an activation button, selection of an activation, clicking an activation button etc. or any action that. directs processor 118 to execute the computer readable code of the specific module or sub-module. In an aspect of an embodiment of the present invention, display of the activation buttons may be done as a default when a user launches the application for grief and loss management system 100 on the user's device, also as a result of processor 118 executing computer readable code necessary for aforesaid display.

As such, aspects of embodiments of the present invention contemplate grief and loss management system 100 to include a set of machine code selected from the native instruction set for enabling the display of a tab or link on each page for the respective module and/or sub module, where the link activates operation of the respective module and/or sub module when a user taps, swipes, selects, or clicks on the link using either the user's finger, mouse, or any other operative device. In an aspect of an embodiment of the present invention, such code may be resident on memory 120 or processor 118. In another aspect of an embodiment of the present invention, such code may be resident on the module or sub module in question.

Additional aspects of embodiments of the present invention contemplate each module and/or sub-module to include a set of machine code selected from the native instruction set for enabling the display of a tab or link on each page for the respective module and/or sub module, where the link activates operation of the respective module and/or sub module when a user taps, swipes, selects, or clicks on the link using either the user's finger, mouse, or any other operative device.

In an aspect of an embodiment of the present invention, onboarding module 102 may include forgot password initiate submodule 102A, forgot password complete submodule 102B, create an account initiate submodule 102C, and create an account confirm submodule 102D.

In an aspect of an embodiment of the present invention, forgot password initiate submodule 102A may include a set of machine code for enabling users of grief and loss management system 100 to initiate a password reset, the machine code being selected from the native instruction set.

In an aspect of an embodiment of the present invention, forgot password initiate submodule 102A may include machine code for displaying an executable link which could be displayed as a tab, link, etc. on a page (not shown) which, upon a user's click, selection, tap, etc., would enable users of grief and loss management system 100 to initiate a password reset, the machine code being selected from the native instruction set. With execution of forgot password initiate submodule 102A, the user would be required to provide his/her email address and grief and loss management system 100 would generate a token and automatically email the user a link which, in one aspect of an embodiment of the present invention, would point or direct the user to a “Forgot Password-Complete’ page upon which the user would be enabled to provide grief and loss management system 100 with a new password. In an aspect of an embodiment of the present invention, the generated token may automatically expire within 2 hours of creation.

In an aspect of an embodiment of the present invention, forgot password complete submodule 102B may include a set of machine code for enabling system users to complete a password reset using a secure link, the machine code being selected from the native instruction set.

In an aspect of an embodiment of the present invention, forgot password complete submodule 102B may be launched by grief and loss management system 100 once the token is generated. The token, in an aspect of an embodiment of the present invention, may be sent by grief and loss management system 100 to the “Forgot Password-Complete’ page, and the token may then be verified by the user. Once the token has been verified by the user, the user would then be enabled to enter his/her new password and saves same by clicking a “Submit” button/link positioned on the “Forgot Password-Complete’ page. The new password, in an aspect of an embodiment of the present invention, is then saved onto memory or database 120. The user may then, in an aspect of an embodiment of the present invention, be logged in to grief and loss management system 100 and redirected to grief and loss management system 100's Landing Page.

In an aspect of an embodiment of the present invention, create an account initiate submodule 102C may include a set of machine code for enabling new users of grief and loss management system 100 to create an account, the machine code being selected from the native instruction set. In an aspect of an embodiment of the present invention, create an account initiate submodule 102C may be selected by a user who intends to create a new account within grief and loss management system 100. Activation of create an account initiate submodule 102C may be implemented by clicking on an activation link that may be displayed as a link, tab, etc. (not shown). With create an account initiate submodule 102C execution/activation, a user would then be enabled to provide their Name (First, Middle, Last), any suffix(es), Email, Mobile Phone Number, Address etc. The user may also be enabled to ‘Opt out of text messages’ normally received from grief and loss management system 100 by selecting or unclicking a checkbox or by any other means of selection. The account creation may be concluded with the user selecting or clicking on a ‘Submit” button or link at which point the information provided by the user is saved or stored in memory 120. The user may still have the option of cancelling the transaction by selection of the “Cancel” button/link.

In an aspect of an embodiment of the present invention, create an account confirm submodule 102D may include a set of machine code for enabling grief and loss management system 100 to automatically confirm that a user's registration is valid through text or email, the machine code being selected from the native instruction set.

Upon selection of a “Submit” button or link, grief and loss management system 100 executes create an account confirm submodule 102D, which then sends an automated text and email with a confirmation link to the mobile number and email address submitted by user. When the user clicks on the link in text or email, it automatically activates the user's new account.

In an aspect of an embodiment of the present invention, menu module 104 may include menu app tutorial submodule 104A, menu milestones at a glance submodule 104B, menu Invite a friend submodule 104C, menu profile submodule 104D, a Terms of service submodule 104E, and a privacy policy submodule 104F.

In an aspect of an embodiment of the present invention, menu app tutorial submodule 104A may include a set of machine code for providing system users with an overview of grief and loss management system 100 when they initially open an application program of grief and loss management system 100, the machine code being selected from the native instruction set. In an aspect of an embodiment of the present invention, execution of menu app submodule 104A may lead to the display or play of information on how to use grief and loss management system 100. In another aspect of an embodiment of the present invention, this could also be a link to a video.

In an aspect of an embodiment of the present invention, menu milestones at a glance 104B submodule may include a set of machine code for enabling users to see all milestones across all of their circles in a calendar view, the machine code being selected from the native instruction set. Execution of menu milestones at a glance 104B submodule enables users to see all milestones across all of their circles in a calendar view, with the ability to toggle through months. In an aspect of an embodiment of the present invention, execution of menu milestones at a glance 104B submodule may also enable display for each circle on the appropriate date. In an aspect of an embodiment of the present invention, such display may include, but not be limited to, the Life Event Name (e.g., ‘Papi’)/Milestone Name (e.g., ‘Birthday’), text that could be a link that will take the user to the ‘Life Event Details’ page for that life event, a ‘Plus’ button next to each event to add to the user's calendar. Selection or clicking the ‘Plus’ button (which implements execution of further code of menu milestones at a glance 104B submodule), enables addition of event(s) to the user's available calendars. In an aspect of an embodiment of the present invention, Invite a friend submodule 104C may include a set of machine code for, enabling a user to invite a friend to become a member of grief and loss management system 100, the machine code being selected from the native instruction set. Execution of Invite a friend submodule 104C enables a user to invite a friend to become a member of grief and loss management system 100. Aforesaid execution may, in an aspect of an embodiment of the present invention, lead to display of text inviting the user to invite a friend to become a member of grief and loss management system 100, while also enabling the user to provide the friend's contact information (such as phone number, email address etc.). Execution of additional code of Invite a friend submodule 104C (by selection of a button/link on a page, not shown) may lead to transmission of an automated text message and/or email message to the invited friend. The message may notify the invited friend of grief and loss management system 100's application and invite the invited friend to download grief and loss management system 100's application from the Apple, Google or similar application platform/store.

In an aspect of an embodiment of the present invention, profile submodule 104D may include a set of machine code for enabling the entering a user's profile information including, without limitation, name, email, mobile phone number, Profile photo, password modification options (e.g., to change, view current password, select new password etc.). The user may also be enabled to opt out of receiving text messages from grief and loss management system 100 by way of selection of a checkbox. When the checkbox is checked, then user will not receive any text messages generated from the application. The information provided by the user may then be saved by way of selection of a “Save” button/link displayed, thereby saving or storing the provided information in memory 120. The user may also be enabled to cancel all information provided before saving or storing such, by clicking or selection of “Cancel” link/button.

In an aspect of an embodiment of the present invention, terms of service submodule 104E may include a set of machine code for enabling display of grief and loss management system 100's Terms of Service, the machine code being selected from the native instruction set.

In an aspect of an embodiment of the present invention, privacy policy submodule 104F may include a set of machine code for displaying grief and loss management system 100's privacy policy, the machine code being selected from the native instruction set.

In an aspect of an embodiment of the present invention, the events module 106 may include add new events submodule 106A, a reach out for support submodule 106B and a life event details submodule 106C. The links/buttons for these submodules may, in an aspect of an embodiment of the present invention, be displayed on grief and loss management system 100's main landing page for logged on users. In an aspect of an embodiment of the present invention, events module 106 may include a set of machine code, which, upon execution, displays elements of grief and loss management system 100's landing page, including, without limitation, links used to execute each one of add new events submodule 106A, a reach out for support submodule 106B and a life event details submodule 106C, a list of life events—each of which may, according to an aspect of an embodiment of the present invention, may be formatted as a card that includes: category name header (e.g. “loss of a Loved One”), color tag (a different color for each category), event name (e.g. “Aunt Debbie”), profile photo (thumbnail), city, state, country fields, “Last Milestone” label, Display date and name of last milestone, “Next Milestones” label, Display date of next 2 milestones (calendar icons), etc. In an aspect of an embodiment of the present invention, advertisements by third parties such as Apple or Google may be enabled to be displayed between event cards as part of the feed.

In an aspect of an embodiment of the present invention, add new events submodule 106A may include a set of machine code for enabling addition of a new life event to grief and loss management system 100, the machine code being selected from the native instruction set. In an aspect of an embodiment of the present invention, add new events submodule 106A may include a set of machine code for enabling a user to enter information for a new event including, without limitation, “Event Title” field (text), “Category” field (e.g., as a dropdown highlighting: loss of a Loved One, loss of a Pet, Job loss, Illness, Others, etc.), “Name of Beloved” field (e.g. the deceased individual), Photo Uploader (to upload a thumbnail photo), City, State, Country fields, “Additional Details” header, “Favorite Holiday” field (text), “Favorite Flower” field (text), “Favorite Movie” Field (text), “Favorite Book” field (text), “Favorite Charitable Cause” field (text), “Occupation” field (text), Others TBD, “Important People” header, “Name” field, “Relation” field (e.g., as a dropdown highlighting: Spouse, Child, Significant Other, Parent, Sibling, Aunt, Uncle, Cousin, Friend, Other relation, etc.). Selection of any one of these information points would lead to execution of the add new events submodule 106A machine code for such information point, thereby enabling a user to provide such information. Once received, the information provided is saved on memory 120 with selection or clicking of the “Save Changes” button.

In an aspect of an embodiment of the present invention, reach out for support submodule 106B may include a set of machine code for enabling a user to let the user's circle members to know that the user is, for instance, in need of their support, the machine code being selected from the native instruction set. Reach out for support submodule 106B may be executed by way of selection or clicking of the corresponding link for “Reach Out for Support” button located on grief and loss management system 100's landing page. Execution of reach out for support submodule 106B may, in an aspect of an embodiment of the present invention, enable a user to send a message to the user's circle that the user is, for instance, having a difficult day and needs support from the user's circle. Aspects of embodiments of the present invention contemplate grief and loss management system 100 using default text(s) or messages to do this. In an aspect of an embodiment of the present invention, grief and loss management system 100 may, upon execution of reach out for support submodule 106B, enable the user to customize the message(s) sent to the user's circle. The message(s) may be sent in a variety of ways, including, without limitation, text, or email. Successful transmission of the message(s) to the user may result in the display of a “Success” message viewable by the user. If there is no one in the user's circle, grief and loss management system 100 would notify the user and enable the user to add at least one member as part of the user's circle.

In an aspect of an embodiment of the present invention, the Life event details submodule 106C may further include an editing submodule 108, a manage milestone submodule 110, and a Manage circles submodule 112. In an aspect of an embodiment of the present invention, editing submodule 108 may include a set of machine code for editing any details of a selected life event, the machine code being selected from the native instruction set. Life event details submodule 106C may be executed by way of selection or clicking of the corresponding link for “Life Event Details” button located on grief and loss management system 100's landing page, thereby leading a user to see a display of information, including, but not limited to, Event Title header, user's thumbnail photo, City, State, Country, “Edit” link, details for each field, such as: Category, Name (e.g., the deceased individual), Favorite Holiday, Favorite Flower, Favorite Movie, Favorite Book, Passion Project, Occupation, Others etc. A user may also see a display of the following: “Important People” header, list of all names and relationships (Name, Relationship), “Milestones” header, “Manage Milestones” link, List of selected Milestones, Calendar icon (shows date of Milestone), Milestone Name, “The Circle” header, “Manage Circle” link, and icons with initials of each member of the Circle. The life events may be edited by use of editing submodule 108 which may be executed by selection of the corresponding editing button/link. Execution of editing submodule 108 may, in an aspect of an embodiment of the present invention, enable a user to edit aspects of any life event currently stored on grief and loss management system 100. These may include editing, deletion, or any change to existing data or information currently stored on memory 120 for the life event. Such information may include, but not be limited to information in the: photo field, category field (e.g., loss of a Loved One, loss of a Pet, Job loss, Illness, etc.), name field (e.g., for the deceased individual's name), additional details field (e.g., “Favorite Holiday” field (text), “Favorite Flower” field (text), “Favorite Book” field (text), “Favorite Charitable Cause” field (text), “Occupation” field (text), etc.), important people field, relation field as a dropdown (e.g., Spouse, Child, Significant Other, Parent, Sibling, Aunt, Uncle, Cousin, Friend, other, etc.).

In an aspect of an embodiment of the present invention, manage milestone submodule 110 may include a set of machine code for managing all milestones related to a life event, the machine code being selected from the native instruction set. The execution of said machine code, which may be possible by selection of manage milestones link/button, may enable modification of information pertaining to milestones stored or to be stored in grief and loss management system 100 by a user. Aspects of embodiments of the present invention contemplate displayed linked tabs for priority and custom milestones, selection or clicking each of which would enable a user to modify certain milestones, which may include, date of death, birthdays, wedding anniversaries, retirement dates etc. Execution of manage milestone submodule 110 may also enable field customization based on the selected life event category in the “life Events Details” section of grief and loss management system 100. Aspects of embodiments of the present invention also contemplate display of a linked tab for holidays in which a checkbox may be displayed next to each listed holiday, with a checked checkbox leading to execution of manage milestone submodule 110's code that would enable display of the checked holiday as a milestone in the “life Events Details” section of grief and loss management system 100.

An aspect of an embodiment of the present invention contemplates grief and loss management system 100 automatically sending a message (text, email, etc.) to all members of the user's circle a certain number of days prior to the milestone date and on the milestone date itself as a reminder. The timeframe for doing this may be preset or set by the user. In one aspect of an embodiment of the present invention, the message may include the name of the life event owner and the deceased so that the recipient may know who to reach out to for support. The message may also include a reminder to look at the life event details for the recipient to obtain more information so the recipient may have an idea of how best to provide the support (e.g., user's relatives, favorite flower, etc.). In instances where the Date of Death” field is not null, grief and loss management system 100 may automatically calculate one month anniversary, six-month anniversary, one year anniversary, and subsequent annual anniversaries and send messages to all members of the Circle a certain number of days prior to the Milestone date and on the Milestone date as a reminder.

In an aspect of an embodiment of the present invention, manage circles submodule 112 may include a set of machine code for managing which users have access to view a selected life event, the machine code being selected from the native instruction set. Execution of manages circles submodule 112 enables editing of information pertaining to a user's circle members, including, without limitation, deletion, editing, addition of new information, search etc. Aspects of embodiments of the present invention also contemplate enabling the user to invite new members to the circle—members who are not yet part of grief and loss management system 100. In an aspect of an embodiment of the present invention, this may be made possible by selection/clicking of link/button indicating “invite”, selection of which would execute certain machine code of manage circles submodule 112 to send an automated text message or email to the recipient with preset or customized wording, inviting the recipient to download the application for grief and loss management system 100.

In an aspect of an embodiment of the present invention, manage circles submodule 112 further may include a my circles submodule 114. In an aspect of an embodiment of the present invention, my circles submodule 114 may include: a first set of machine code for creation of memory data structures, within memory 120 for storing life event details, where the first set of machine code are selected from the native instruction set, a second set of machine code for displaying icons or labels for each of the life event details. In an aspect of an embodiment of the present invention, the second set of machine code are selected from the native instruction set, a third set of machine code for calculating calendar dates for certain life event details. In an aspect of an embodiment of the present invention, the third set of machine code is selected from the native instruction set. In an aspect of an embodiment of the present invention, execution of machine code my circles submodule 114 may enable display of each circle as a card that includes, inter alia, category name header (e.g., “loss of a Loved One”), color tag (a different color for each category), Event Name (e.g. “Granddad”), Thumbnail photo, Event Creator (“Created by [Name]”), “Last Milestone” label, Display date and name of last milestone, “Next Milestones” label, and Display the date of next 2 milestones (calendar icons). In an aspect of an embodiment of the present invention, execution of machine code my circles submodule 114 may also enable display of the details of a selected life event, including, without limitation, Display name of Event as header (e.g., “Papi”), Thumbnail photo, City, State, Country, “Created by [Event Creator Name]” (e.g. Joe Smith), List of read-only information (Category, Name (e.g. name of deceased), Favorite Holiday, Favorite Flower, Favorite Movie, Favorite Book, Passion Project, Occupation, etc.), “Important People” Header—list of individuals (Name, Relation), “Milestones” header, List of Milestones with calendar icon (showing milestone date), Milestone Name), “Circle” header, etc. Also displayed may be icons with the initials of each member of the Circle; including their first name and last initial next to each icon. Further displayed may be a floating “Offer Support” link/button, selection of which would execute offer support module 116.

In an aspect of an embodiment of the present invention, offer support module 116 may include a text message submodule 116A, email submodule 116B and combination text and email submodule 116C. Execution of offer support module 116 enables users to send a text or email message to a Life Event creator directly through grief and loss management system 100. Execution of certain machine code of offer support module 116 enables display of preset message options with radio buttons next to each. Execution of other machine code of offer support module 116 may enable generation of customized messages as well.

Execution of combination text and email submodule 116C, may be made possible by clicking on a display/link or tab displayed on a landing page of grief and loss management system 100 (not shown), in one aspect of an embodiment of the present invention, selection/clicking of which would enable transmission of the desired message both as a text message and an email message to the recipient. Following such selection, a user may be presented with a sub-header display which may enable the user to send a message to an event creator about a particular event. In an aspect of an embodiment of the present invention, with execution of combination text and email submodule 116C, the user may be presented with preset message options with radio buttons next to each to select each. These may include, but not be limited to, preset messages such as: Thinking of you today, Sending you strength on this difficult day, Wishing you peace today, Call me if you need to, etc.

Aspects of embodiments of the present invention may also present the user with the option of typing their own custom message. Under this aspect of an embodiment of the present invention, execution of combination text and email submodule 116C's machine code will launch the user's native messaging application so that they can compose and send their own text.

In an aspect of an embodiment of the present invention, text message submodule 116A may include: a first set of machine code for sending a desired message as a text message to a recipient's device, the first set of machine code being selected from the native instruction set, a second set of machine code for displaying a button for activation of the send as text message submodule 116A, the second set of machine code being selected from set instruction set.

In an aspect of an embodiment of the present invention, email submodule 116B may include a first set of machine code for sending a desired message as an email to a recipient's email, the first set of machine code being selected from the native instruction set and a second set of machine code for displaying an activation button for email submodule 116B, the second set of machine code being selected from the native instruction set.

In an aspect of an embodiment of the present invention, email submodule 116B may include a first set of machine code for sending a desired preset message as both an email message to a recipient, the first set of machine code being selected from the native instruction set, a second set of machine code for displaying an activation button (not shown), which activates the email submodule 116B, the second set of machine code being selected from the native instruction set.

In an aspect of an embodiment of the present invention, selection, depressing, touching, etc. of the displayed activation button may, in an aspect of an embodiment of the present invention lead to processor(s) 118's execution of email submodule 116B's computer readable code. Such execution may enable transmission of the selected message as an email message. In an aspect of an embodiment of the present invention, the end of the transmitted message may include the Event Creator's Name so a recipient would know from whom the message is from. Another aspect of an embodiment of the present invention may originate a “no reply” email address and phone number.

In an aspect of an embodiment of the present invention, combination text and email submodule 116C may include a first set of machine code for sending a desired preset message as both an email and a text message to a recipient the first set of machine code being selected from the native instruction set, a second set of machine code for displaying an activation button (not shown), which activates the combination text and email submodule 116C, the second set of machine code being selected from the native instruction set.

In an aspect of an embodiment of the present invention, selection, depressing, touching, etc. of the displayed activation button may, in an aspect of an embodiment of the present invention lead to processor(s) 118's execution of combination text and email submodule 116C's computer readable code. Such execution may enable transmission of the selected message as both an email and a text message. In an aspect of an embodiment of the present invention, the end of the transmitted message may include “[Event Creator Name]” so a recipient would know from whom the message is from. Another aspect of an embodiment of the present invention may originate a “no reply” email address and phone number.

Processor(s) 118's execution of combination text and email submodule 116C's computer readable code may, in one aspect of an embodiment of the present invention, enable expansion of the number of reminders and support beyond grief and loss. Execution of combination text and email submodule 116C by processor 118 may also, in an aspect of an embodiment of the present invention, enable incorporation of additional life milestones and setbacks, including, without limitation: wedding anniversaries, job loss, community support donates to bereaved child's tuition, or remembering the bereaved (grief triggers) at weddings, graduation, etc. This additional information may serve as data points that may be saved in memory 120 in different memory structures, including, without limitation, data structures, registers, etc.

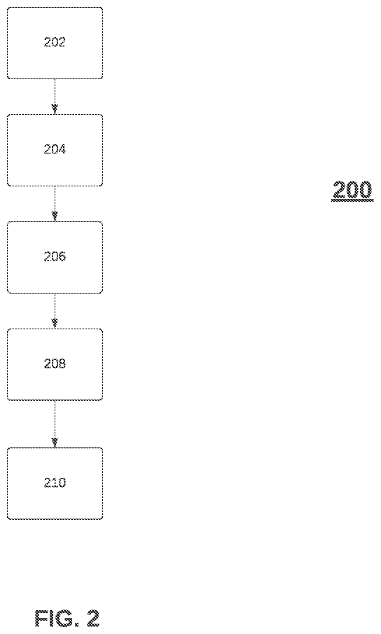

Referring now to FIG. 2, a process 200 showing an exemplary operational process of a grief and loss management system 100, is shown according to aspects of embodiments of the present invention. It should be noted that additional processes are contemplated according to aspects of embodiments of the present invention, involving the different modules and/or sub-modules of grief and loss management system 100. Additional aspects of embodiments of the present invention also contemplate additional processes based on a system user's status as a new or present user of grief and loss management system 100. Further still, additional processes are contemplated according to aspects of embodiments of the present invention, based on iterations of at least one hardware processor 118 during the different stages of operation of grief and loss management system 100.

Process 200, in an aspect of an embodiment of the present invention, contemplates a computer implemented method or process of operating a grief and loss management system 100, which may include, executing on at least one hardware processor 118, the steps of: operation step 202 of onboarding module 102, which may include steps for onboarding at least one user to grief and loss management system 100 and steps for enabling creation of a community circle of the at least one user, operation step 204 of menu module 104, which may include steps for display and operation step of grief and loss management system 100's navigation options and information pertaining to grief and loss management system 100, operation step 206 of an events module 106, which may include steps for collection of any one or more of the at least one user's: events, milestones, operation step 208 of an offer support module 116, which may include steps for enabling communication between grief and loss management system 100 users. In an aspect of an embodiment of the present invention, the at least one hardware processor 118 may be in communication with grief and loss management system 100 modules, and operation step 210 of a communications module 122, which may include steps for enabling at least one interaction between at least one grief and loss management system 100 user and steps for enabling communication between modules of grief and loss management system 100. Aspects of embodiments of the present invention contemplate the “operation” of modules or sub modules of the present invention to include the execution of machine code of such modules or sub modules.

In another aspect of an embodiment of the present invention, operation step 202 of onboarding module 102 may include: operation step of forgot password initiate submodule 102A, operation or execution step of forgot password complete submodule 102B, operation or execution step of create an account initiate submodule 102C, and operation or execution step of create an account confirm submodule 102D.

In another aspect of an embodiment of the present invention, operation step of forgot password initiate submodule 102A may include steps for enabling users of the grief and loss management system 100 to initiate a password reset. In another aspect of an embodiment of the present invention, operation step of forgot password complete submodule 102B may include steps for enabling grief and loss management system 100 users to complete a password reset using a secure link. In another aspect of an embodiment of the present invention, operation step of create an account initiate submodule 102C may include steps for enabling new users of the grief and loss management system 100 to create an account. In another aspect of an embodiment of the present invention, operation step of create an account confirm submodule 102D may include steps for enabling the grief and loss management system 100 to automatically confirm that a user's registration is valid through text or email.

In another aspect of an embodiment of the present invention, operation step 204 of menu module 104 may include: operation step of menu app tutorial submodule 104A, operation step of menu milestones at a glance 104B submodule, operation step of menu Invite a friend submodule 104C, operation step of menu profile submodule 104D, operation step of a Terms of service submodule 104E, and operation step of a privacy policy submodule 104F.

In another aspect of an embodiment of the present invention, operation step of menu app tutorial submodule 104A may include steps for providing users of grief and loss management system 100 with an overview of the grief and loss management system 100 when they initially open an application program of grief and loss management system 100, where operation step of menu milestones at a glance 104B submodule may include steps for enabling users to see all milestones across all of their circles in a calendar view. In another aspect of an embodiment of the present invention, operation step of menu Invite a friend submodule 104C may include steps for inviting, enabling a user to invite a friend to become a member of the grief and loss management system 100. In another aspect of an embodiment of the present invention, operation step of terms of service submodule 104E may include steps for enabling display of the grief and loss management system 100's Terms of Service, and where operation step of privacy policy submodule 104F may include steps for displaying the grief and loss management system 100's privacy policy.

In another aspect of an embodiment of the present invention, operation step 206 of events module 106 may include: operation step of add new events submodule 106A, operation step of a reach out for support submodule 106B and operation step of a life event details submodule 106C,

In another aspect of an embodiment of the present invention, operation step of add new events submodule 106 may include steps for enabling addition of a new life event to the grief and loss management system 100. In another aspect of an embodiment of the present invention, operation step of reach out for support submodule 106B may include steps for enabling a user to use circle members to notify grief and loss management system 100 members. In another aspect of an embodiment of the present invention, operation step of the Life event details submodule 106C may include operation step of an editing submodule 108, operation step of a manage milestone submodule 110, and operation step of a Manage circles submodule 112. In another aspect of an embodiment of the present invention, operation step of editing submodule 108 may include steps for editing any details of a selected life event, and where operation step of manage milestone submodule 110 may include steps for managing all milestones related to a life event. In another aspect of an embodiment of the present invention, operation step of manage circles submodule 112 may include steps for managing which users have access to view a selected life event.

In another aspect of an embodiment of the present invention, operation step of manage circles submodule 112 may include operation step of a My circles submodule 114. In another aspect of an embodiment of the present invention, operation step of my circles submodule 114 may include: steps for creation of memory data structures, within memory 120 for storing life event details, steps for displaying icons or labels for each of the life event details, steps for calculating calendar dates for certain life event details.

In another aspect of an embodiment of the present invention, operation step 208 of offer support module 116 may include: operation step of a text message submodule 116A, operation step of an email submodule 116B and operation step of a combination text and email submodule 116C.

In another aspect of an embodiment of the present invention, operation step of text message submodule 116A may include: steps for sending a desired message as a text message to a recipient's device, steps for displaying a button for activation of the send as text message submodule 116A, where operation step of the email submodule 116B may include steps for sending a desired message as an email message to a recipient's email, and steps for displaying an activation button for the email submodule 116B. In another aspect of an embodiment of the present invention, operation step of the combination text and email submodule 116C may include steps for sending a desired preset message as both an email and a text message to a recipient and steps for displaying an activation button, which activates the combination text and email submodule 116C.

Further aspects of embodiments of the present invention contemplate a computer programmable product which may include a non-transitory computer readable medium having control logic stored therein for causing at least one processor 118 to operate a grief and loss management system 100 which may include executing on at least one processor 118, computer readable code for: operation of onboarding module 102, which may include computer readable code for onboarding at least one user to grief and loss management system 100 and computer readable code for enabling creation of a community circle of the at least one user, operation of menu module 104, which may include computer readable code for display and computer readable code for operation of grief and loss management system 100's navigation options and information pertaining to grief and loss management system 100, operation of a communications module 122, which may include computer readable code for enabling at least one interaction between at least one grief and loss management system 100 user and computer readable code for enabling communication between modules of grief and loss management system 100, operation of an events module 106, which may include computer readable code for collection of any one or more of the at least one user's: events, milestones, and operation of an offer support module 116, which may include computer readable code for enabling communication between grief and loss management system 100 users. In another aspect of an embodiment of the present invention, at least one hardware processor 118 may be in communication with grief and loss management system 100 modules.

In a further aspect of an embodiment of the present invention, the computer readable code for operation of onboarding module 102 may include: computer readable code for operation of forgot password initiate submodule 102A, computer readable code for operation of forgot password complete submodule 102B, computer readable code for operation of create an account initiate submodule 102C, and computer readable code for operation of create an account confirm submodule 102D.

In a further aspect of an embodiment of the present invention, the computer readable code for operation of forgot password initiate submodule 102A may include computer readable code for enabling users of the grief and loss management system 100 to initiate a password reset. In a further aspect of an embodiment of the present invention, computer readable code for computer readable code for operation of forgot password complete submodule 102B may include computer readable code for enabling grief and loss management system 100 users to complete a password reset using a secure link. In a further aspect of an embodiment of the present invention, computer readable code for operation of create an account initiate submodule 102C may include computer readable code for enabling new users of the grief and loss management system 100 to create an account. In another aspect of an embodiment of the present invention, computer readable code for operation of create an account confirm submodule 102D may include computer readable code for enabling the grief and loss management system 100 to automatically confirm that a user's registration is valid through text or email.

In a further aspect of an embodiment of the present invention, the computer readable code for operation of menu module 104 may include: computer readable code for operation of menu app tutorial submodule 104A, computer readable code for operation of menu milestones at a glance 104B submodule, computer readable code for operation of menu Invite a friend submodule 104C, computer readable code for operation of menu profile submodule 104D, computer readable code for operation of a Terms of service submodule 104E, and computer readable code for operation of a privacy policy submodule 104F.

In a further aspect of an embodiment of the present invention, the computer readable code for operation of menu app tutorial submodule 104A may include computer readable code for providing grief and loss management system 100 users with an overview of the grief and loss management system 100 when they initially open an application program of grief and loss management system 100, where computer readable code for operation of menu milestones at a glance 104B submodule may include computer readable code for enabling users to see all milestones across all of their circles in a calendar view. In a further aspect of an embodiment of the present invention, the computer readable code for operation of menu Invite a friend submodule 104C may include computer readable code for inviting, enabling a user to invite a friend to become a member of the grief and loss management system 100. In a further aspect of an embodiment of the present invention, the computer readable code for operation of terms of service submodule 104E may include computer readable code for enabling display of the grief and loss management system 100's Terms of Service, and where computer readable code for operation of privacy policy submodule 104F may include computer readable code for displaying the grief and loss management system 100's privacy policy.

In a further aspect of an embodiment of the present invention, the computer readable code for operation of the events module 106 may include: computer readable code for operation of add new events submodule 106A, computer readable code for operation of a reach out for support submodule 106B and computer readable code for operation of a life event details submodule 106C,

In a further aspect of an embodiment of the present invention, the computer readable code for operation of the add new events submodule 106 may include computer readable code for enabling addition of a new life event to the grief and loss management system 100, where computer readable code for operation of reach out for support submodule 106B may include computer readable code for enabling a user to use circle members to notify grief and loss management system 100 members. In a further aspect of an embodiment of the present invention, the computer readable code for operation of the Life event details submodule 106C may include computer readable code for operation of an editing submodule 108, computer readable code for operation of a manage milestone submodule 110, and computer readable code for operation of a Manage circles submodule 112. In a further aspect of an embodiment of the present invention, the computer readable code for operation of editing submodule 108 may include computer readable code for editing any details of a selected life event, and where computer readable code for operation of manage milestone submodule 110 may include computer readable code for managing all milestones related to a life event. In a further aspect of an embodiment of the present invention, the computer readable code for operation of manage circles submodule 112 may include computer readable code for managing which users have access to view a selected life event.

In a further aspect of an embodiment of the present invention, the computer readable code for operation of manage circles submodule 112 may include computer readable code for operation of a My circles submodule 114. In a further aspect of an embodiment of the present invention, the computer readable code for operation of my circles submodule 114 may include: computer readable code for creation of memory data structures, within memory 120 for storing life event details, computer readable code for displaying icons or labels for each of the life event details, computer readable code for calculating calendar dates for certain life event details.

In a further aspect of an embodiment of the present invention, the computer readable code for operation of offer support module 116 may include: computer readable code for operation of a text message submodule 116A, computer readable code for operation of an email submodule 116B and computer readable code for operation of a combination text and email submodule 116C.

In a further aspect of an embodiment of the present invention, the computer readable code for operation of text message submodule 116A may include: computer readable code for sending a desired message as a text message to a recipient's device, computer readable code for displaying a button for activation of the send as text message submodule 116A, where computer readable code for operation of the email submodule 116B may include computer readable code for sending a desired message as an email message to a recipient's email, and computer readable code for displaying an activation button for the email submodule 116B. In a further aspect of an embodiment of the present invention, the computer readable code for operation of the combination text and email submodule 116C may include computer readable code for sending a desired preset message as both an email and a text message to a recipient and computer readable code for displaying an activation button, which activates the combination text and email submodule 116C.

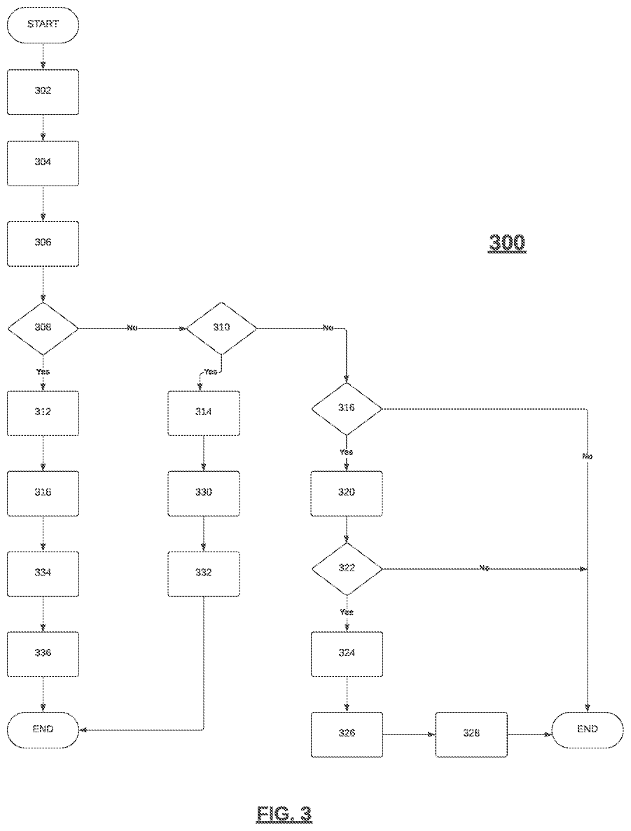

Referring now to FIG. 3, a privacy process 300 of grief and loss management system 100 is shown according to aspects of embodiments of the present invention. Problems pertaining to privacy may arise during the operation of grief and loss management system 100, specifically pertaining to identity impersonation. For instance, if an account is created within grief and loss management system 100 by a party other than the bereaved, that party should not do so under the bereaved's identity, but rather under their own identity. This may also comport with one aspect of an embodiment of the present invention which contemplates account creation by a primary person who may be a member of the bereaved's support circle. This recognizes that the bereaved may not be in the mental state to create an account and populate grief and loss management system 100 with all relevant data. Rather, a member of the bereaved's support circle may be able to do so. Accordingly, process 300 seeks to address this problem.

Process 300 begins with the death and/or notification of an individual's death in step 302. A member of the bereaved's support circle may, in step 304, create an account within grief and loss management system 100. The member of the bereaved's support circle may then, in step 306 (using menu invite a friend sub-module 104C, according to one aspect of an embodiment of the present invention), invite the bereaved to join the circle within grief and loss management system 100 using the bereaved's email address. The bereaved's support circle member may also mark or identify the bereaved as a “Family Member”. In aspects of embodiments of the present invention, the machine code necessary for process 300 may be part of sub-module 104C's machine code and may include set(s) of machine code selected from the native instruction set for enabling process 300. In other aspects of embodiments of the present invention, sub-module 104C may interact with other elements of grief and loss management system 100, including, without limitation, memory 120, “reach out for support” sub-module 106B, “life events” sub-module 106C, milestones sub-module 110, “my circles” sub-module 114, and any other elements of grief and loss management system 100, as necessary, in order to conduct steps of process 300.

Referring back to FIG. 3, next, in decisional step 308, the bereaved receives the invitation and has to decide whether to accept the invitation or not. If the bereaved accepts the invitation, process 300 proceeds to step 312 where the bereaved creates a complete profile with grief and loss management system 100, which may include the provision of pertinent information, including, without limitation, the bereaved's phone and email information.

If at decisional step 308 the bereaved does not accept the invitation, grief and loss management system 100 would present the bereaved, in step 310, with a “soft accept” offer and a full decline offer. In an aspect of an embodiment of the present invention, the “soft accept” offer enables the bereaved to indicate, in step 314, their interest to be contacted to sign up for grief and loss management system 100. In another aspect of an embodiment of the present invention, the “soft accept” offer would enable the bereaved to receive communication and/or support from the bereaved support circle, without the bereaved being a part of grief and loss management system 100. In yet another aspect of an embodiment of the present invention, the “soft accept” offer may: enable the bereaved to indicate their interest to be contacted to sign up for grief and loss management system 100, enable the bereaved to receive communication and/or support from the bereaved support circle, without the bereaved being a part of grief and loss management system 100, and/or enable the bereaved to provide, in step 330 a partial profile with certain information, such as their phone number, email address etc. In the instance where the bereaved provides for their contact information, support circle members, in step 332 may then be able to offer support to the bereaved using the provided contact information.

If, at decisional step 310, the bereaved does a full decline, grief and loss management system 100 would then inquire, in step 316 the reason for the bereaved's invitation decline. If the bereaved decides not to provide a reason, the process ends. If the bereaved decides to provide a reason, process 300 proceeds to step 320, where the bereaved is enabled to provide a reason. Next, in decisional step 322, the bereaved is then asked as to whether the reason pertains to the central person not being deceased. If the bereaved answers “no”, process 300 ends. If the bereaved answers in the affirmative, process 300 proceeds to step 324 where the bereaved is enabled to submit a dispute to grief and loss management system 100. Administrators administering grief and loss management system 100, will then, in step 326 receive the dispute and take appropriate action in step 328, after which process 300 ends.

Going back to decisional step 308, if the bereaved accepts the invitation, the bereaved, in step 312 creates a full profile by providing pertinent information such as their email address, phone number, etc. Next, in step 318, as a circle member, the bereaved would be enabled to complete the loss event details of the bereaved. The bereaved would also be enabled to update the milestones for the dead individual.

Next, in step 334, every family member of the dead individual would be able to request help from each other or from other members of the bereaved's circle who are not family members. Finally, circle members, in step 336, may be enabled to choose one or more family members of the dead individual to offer help. Process 300 then ends.

Although this present invention has been disclosed with reference to specific forms and embodiments, it will be evident that a considerable number of variations may be made without departing from the spirit and scope of the present invention. For example, steps may be reversed, equivalent elements may be substituted for those specifically disclosed and certain features of the present invention may be used independently of other features—all without departing from the present invention as outlined above, in the appended figures and the claims presented below.

What is claimed is:

1. A grief and loss management system, comprising:
at least one hardware processor configured to perform a predefined set of basic operations in response to receiving a corresponding basic instruction selected from a predefined native instruction set of code;
memory, in communication with said at least one hardware processor;
an onboarding module, comprising a first set of machine code selected from said native instruction set for initial onboarding of at least one user to said grief and loss management system and second set of machine code for enabling creation of a community circle of said at least one user;
a menu module, comprising a set of machine code selected from said native instruction set for displaying said system's navigation options and information pertaining to said system;
a communications module, comprising a set of machine code selected from said native instruction set for enabling at least one interaction between at least one grief and loss management system user and for enabling communication between modules of said grief and loss management system;
an events module, comprising a set of machine code selected from said native instruction set for collection of any one or more of said at least one user's: events, milestones; and
an offer support module, comprising a set of machine code selected from said native instruction set for enabling communication between system users, wherein said at least one hardware processor is in communication with said system modules.

2. The system of claim 1, wherein said onboarding module further comprises of a Forgot Password Initiate submodule, a Forgot Password Complete submodule, a Create an Account Initiate submodule, and a Create an Account Confirm submodule.

3. The system of claim 2, wherein said Forgot Password Initiate submodule comprises of a set of machine code for enabling users of the system to initiate a password reset, said machine code being selected from said native instruction set, wherein said Forgot Password Complete submodule comprises of a set of machine code for enabling system users to complete a password reset using a secure link, said machine code being selected from said native instruction set, wherein said Create an Account Initiate submodule comprises of a set of machine code for enabling new users of the system to create an account, said machine code being selected from said native instruction set and, wherein said Create an Account Confirm submodule comprises of a set of machine code for enabling the system to automatically confirm that a user's registration is valid through text or email, said machine code being selected from said native instruction set.

4. The system of claim 1, wherein said menu module further comprises of a menu app tutorial submodule, a menu milestones at a glance submodule, a menu invite a friend submodule, a menu profile submodule, a Terms of Service submodule, and a privacy policy submodule.

5. The system of claim 4, wherein said menu invite a friend submodule comprises of a set of machine code for any one or more of: enabling a user to invite at least one bereaved person to become a member of said grief and loss management system, enabling action by said at least one bereaved person in response to said invitation, enabling inclusion of said at least one bereaved person into a support circle without creating an account for said at least one bereaved person, enabling said at least one bereaved person to receive communication and/or support from said support circle, without said at least one bereaved being a part of said grief and loss management system, enabling said at least one bereaved person to indicate their interest to be contacted to sign up for said grief and loss management system.

6. The system of claim 1, wherein said events module comprises of an add new events submodule, a reach out for support submodule and a life event details submodule.

7. The system of claim 6, wherein said add new events submodule comprises of a set of machine code for enabling addition of a new life event to the system, said machine code being selected from said native instruction set, wherein said reach out for support submodule comprises of a set of machine code for enabling a user to use circle members to notify system members, said machine code being selected from said native instruction set, wherein said Life Event Details submodule further comprises of an editing submodule, a manage milestone submodule, and a Manage Circles submodule, wherein said editing submodule comprises of a set of machine code for editing any details of a selected life event, said machine code being selected from said native instruction set, and wherein said manage milestone submodule comprises of a set of machine code for managing all milestones related to a life event, said machine code being selected from said native instruction set, wherein said Manage Circles submodule comprises of a set of machine code for managing which users have access to view a selected life event, said machine code being selected from said native instruction set.

8. The system of claim 7, wherein said Manage Circles submodule further comprises of a My Circles submodule, wherein said My Circles submodule comprises of: a first set of machine code for creation of memory data structures, within said memory for storing life event details, wherein said first set of machine code are selected from said native instruction set, a second set of machine code for displaying icons or labels for each of said life event details, wherein said second set of machine code are selected from said native instruction set, a third set of machine code for calculating calendar dates for certain life event details, wherein said third set of machine code is selected from said native instruction set.

9. The system of claim 1, wherein said offer support module comprises of a text message submodule, an email submodule and a combination text and email submodule.

10. The system of claim 9, said text message submodule comprises of: a first set of machine code for sending a desired message as a text message to a recipient's device, said first set of machine code being selected from said native instruction set, a second set of machine code for displaying a button for activation of said send as text message submodule, said second set of machine code being selected from set instruction set, wherein said email submodule comprises of a first set of machine code for sending a desired message as an email message to a recipient's email, said first set of macing code being selected from said native instruction set and a second set of machine code for displaying an activation button for said email submodule, said second set of machine code being selected from said native instruction set, wherein said combination text and email submodule comprises of a first set of machine code for sending a desired preset message as both an email and a text message to a recipient said first set of machine code being selected from said native instruction set, a second set of machine code for displaying an activation button, which activates said combination text and email submodule, said second set of machine code being selected from said native instruction set.

11. A computer implemented method of operating a grief and loss management system, comprising, executing on at least one hardware processor, the steps of:
operation of an onboarding module, comprising steps for onboarding at least one user to said grief and loss management system and steps for enabling creation of a community circle of said at least one user;
operation of a menu module, comprising steps for display and operation of said grief and loss management system's navigation options and information pertaining to said grief and loss management system;
operation of a communications module, comprising steps for enabling at least one interaction between at least one grief and loss management system user and steps for enabling communication between modules of said grief and loss management system;
operation of an events module, comprising steps for collection of any one or more of said at least one user's: events, milestones; and
operation of an offer support module, comprising steps for enabling communication between grief and loss management system users, wherein said at least one hardware processor is in communication with said grief and loss management system modules.

12. The computer implemented method of claim 11, wherein operation of said onboarding module further comprises: operation of a Forgot Password Initiate submodule, operation of a Forgot Password Complete submodule, operation of a Create an Account Initiate submodule, and operation of a Create an Account Confirm submodule.

13. The computer implemented method of claim 12, wherein operation of said Forgot Password Initiate submodule comprises steps for enabling users of the grief and loss management system to initiate a password reset, wherein operation of said Forgot Password Complete submodule comprises steps for enabling grief and loss management system users to complete a password reset using a secure link, wherein operation of said Create an Account Initiate submodule comprises steps for enabling new users of the grief and loss management system to create an account, wherein operation of said Create an Account Confirm submodule comprises steps for enabling the grief and loss management system to automatically confirm that a user's registration is valid through text or email.

14. The computer implemented method of claim 11, wherein operation of said menu module further comprises: operation of a menu invite a friend submodule, wherein operation of said menu module further comprises steps for operation of a menu invite a friend submodule, wherein said steps for operation of said menu invite a friend submodule further comprises steps for any one or more of: enabling a user to invite at least one bereaved person to become a member of said grief and loss management system, enabling action by said at least one bereaved person in response to said invitation, enabling inclusion of said at least one bereaved person into a support circle without creating an account for said at least one bereaved person, enabling said at least one bereaved person to receive communication and/or support from said support circle, without said at least one bereaved being a part of said grief and loss management system, enabling said at least one bereaved person to indicate their interest to be contacted to sign up for said grief and loss management system.

15. The computer implemented method of claim 11, wherein operation of said events module comprises: operation of an add new events submodule, operation of a reach out for support submodule and operation of a life event details submodule.

16. The computer implemented method of claim 15, wherein operation of said add new events submodule comprises steps for enabling addition of a new life event to the grief and loss management system, wherein operation of said reach out for support submodule comprises steps for enabling a user to use circle members to notify grief and loss management system members, wherein operation of said Life Event Details submodule further comprises operation of an editing submodule, operation of a manage milestone submodule, and operation of a Manage Circles submodule, wherein operation of said editing submodule comprises steps for editing any details of a selected life event, and wherein operation of said manage milestone submodule comprises steps for managing all milestones related to a life event, wherein operation of said Manage Circles submodule comprises steps for managing which users have access to view a selected life event.

17. The computer implemented method of claim 16, wherein operation of said Manage Circles submodule further comprises operation of a My Circles submodule, wherein operation of said My Circles submodule comprises: steps for creation of memory data structures, within said memory for storing life event details, steps for displaying icons or labels for each of said life event details, steps for calculating calendar dates for certain life event details.

18. The computer implemented method of claim 11, wherein operation of said offer support module comprises: operation of a text message submodule, operation of an email submodule and operation of a combination text and email submodule.

19. The computer implemented method of claim 18, operation of said text message submodule comprises of: steps for sending a desired message as a text message to a recipient's device, steps for displaying a button for activation of said send as text message submodule, wherein operation of said email submodule comprises of steps for sending a desired message as an email message to a recipient's email, and steps for displaying an activation button for said email submodule, wherein operation of said combination text and email submodule comprises of steps for sending a desired preset message as both an email and a text message to a recipient and steps for displaying an activation button, which activates said combination text and email submodule.

20. A computer programmable product comprising a non-transitory computer readable medium having control logic stored therein for causing at least one processor to operate a grief and loss management system comprising executing on at least one processor, computer readable code for:
operation of an onboarding module, comprising computer readable code for onboarding at least one user to said grief and loss management system and computer readable code for enabling creation of a community circle of said at least one user;
operation of a menu module, comprising computer readable code for display and computer readable code for operation of said grief and loss management system's navigation options and information pertaining to said grief and loss management system;
operation of a communications module, comprising computer readable code for enabling at least one interaction between at least one grief and loss management system user and computer readable code for enabling communication between modules of said grief and loss management system;
operation of an events module, comprising computer readable code for collection of any one or more of said at least one user's: events, milestones; and
operation of an offer support module, comprising computer readable code for enabling communication between grief and loss management system users, wherein said at least one hardware processor is in communication with said grief and loss management system modules.

21. The computer programmable product of claim 20, wherein computer readable code for operation of said onboarding module further comprises: computer readable code for operation of a Forgot Password Initiate submodule, computer readable code for operation of a Forgot Password Complete submodule, computer readable code for operation of a Create an Account Initiate submodule, and computer readable code for operation of a Create an Account Confirm submodule.

22. The computer programmable product of claim 21, wherein computer readable code for operation of said Forgot Password Initiate submodule comprises computer readable code for enabling users of the grief and loss management system to initiate a password reset, wherein computer readable code for computer readable code for operation of said Forgot Password Complete submodule comprises computer readable code for enabling grief and loss management system users to complete a password reset using a secure link, wherein computer readable code for operation of said Create an Account Initiate submodule comprises computer readable code for enabling new users of the grief and loss management system to create an account, wherein computer readable code for operation of said Create an Account Confirm submodule comprises computer readable code for enabling the grief and loss management system to automatically confirm that a user's registration is valid through text or email.

23. The computer programmable product of claim 20, wherein computer readable code for operation of said menu module further comprises computer readable code for operation of a menu invite a friend submodule, wherein said computer readable code for operation of said menu invite a friend submodule further comprises: computer readable code for any one or more of: enabling a user to invite at least one bereaved person to become a member of said grief and loss management system, enabling action by said at least one bereaved person in response to said invitation, enabling inclusion of said at least one bereaved person into a support circle without creating an account for said at least one bereaved person, enabling said at least one bereaved person to receive communication and/or support from said support circle, without said at least one bereaved being a part of said grief and loss management system, enabling said at least one bereaved person to indicate their interest to be contacted to sign up for said grief and loss management system.

24. The computer programmable product of claim 20, wherein computer readable code for operation of said events module comprises: computer readable code for operation of an add new events submodule, computer readable code for operation of a reach out for support submodule and computer readable code for operation of a life event details submodule.

25. The computer programmable product of claim 24, wherein computer readable code for operation of said add new events submodule comprises computer readable code for enabling addition of a new life event to the grief and loss management system, wherein computer readable code for operation of said reach out for support submodule comprises computer readable code for enabling a user to use circle members to notify grief and loss management system members, wherein computer readable code for operation of said Life Event Details submodule further comprises computer readable code for operation of an editing submodule, computer readable code for operation of a manage milestone submodule, and computer readable code for operation of a Manage Circles submodule, wherein computer readable code for operation of said editing submodule comprises computer readable code for editing any details of a selected life event, and wherein computer readable code for operation of said manage milestone submodule comprises computer readable code for managing all milestones related to a life event, wherein computer readable code for operation of said Manage Circles submodule comprises computer readable code for managing which users have access to view a selected life event.

26. The computer programmable product of claim 25, wherein computer readable code for operation of said Manage Circles submodule further comprises computer readable code for operation of a My Circles submodule, wherein computer readable code for operation of said My Circles submodule comprises: computer readable code for creation of memory data structures, within said memory for storing life event details, computer readable code for displaying icons or labels for each of said life event details, computer readable code for calculating calendar dates for certain life event details.

27. The computer programmable product of claim 20, wherein computer readable code for operation of said offer support module comprises: computer readable code for operation of a text message submodule, computer readable code for operation of an email submodule and computer readable code for operation of a combination text and email submodule.

28. The computer programmable product of claim 27, computer readable code for operation of said text message submodule comprises of: computer readable code for sending a desired message as a text message to a recipient's device, computer readable code for displaying a button for activation of said send as text message submodule, wherein computer readable code for operation of said email submodule comprises of computer readable code for sending a desired message as an email message to a recipient's email, and computer readable code for displaying an activation button for said email submodule, wherein computer readable code for operation of said combination text and email submodule comprises of computer readable code for sending a desired preset message as both an email and a text message to a recipient and computer readable code for displaying an activation button, which activates said combination text and email submodule.
